(19) United States
(12) Patent Application Publication
(10) Pub. No.: US 2012/0111170 A1
(43) Pub. Date: May 10, 2012

(54) Chain saw stand

(75) Inventor: Michael David Steinfort, Kingston (CA)

(73) Assignee: Michael David Steinfort, Kingston (CA)

(21) Appl. No.: 12/927,139

(22) Filed: Nov. 9, 2010

(51) Int. Cl. B27B 17/00; B27B 17/02

(52) U.S. Cl. 83/796; 83/574

(57) ABSTRACT

A portable apparatus for cross-cutting material is described. The apparatus secures a chain saw to a swing-arm and is controlled with a tensioning spring, allowing the operator the ease of maneuvering the chain saw. The apparatus supporting-legs splay outwards giving a positional height to allow cut material to fall free off the apparatus.

### BACKGROUND OF THE INVENTION

There are disadvantages of cutting timber or branches that lie on the ground. The chain saws cutting bar tip can hit the ground, causing the chain saw to become dull or the saw to kick-back. Holding the work-piece when cutting is difficult, as the operator may be off balance holding the timber with one foot, and an inappropriate position may cause back-strain. Cutting timber on a sawhorse that may require two people, one to hold and move the timber and one person to operate the chain saw. Timber or branches that are twisted, bent or crooked that are placed on a bench surface or in a trough of a chain saw support table can bind and jam the chain saw cutting chain. Manual chain saw support tables may require the chain saw and the guide-bar to be dedicated to the apparatus, the position of the chain saw may make it difficult to start the engine, and it may be difficult to refill with gasoline and chain-oil. Chain saw tables that have four supporting-legs require a level surface or an adjustment to stop rocking.

### SUMMARY OF THE INVENTION

An apparatus as described herein may be used with a chain saw to cross-cut lengths of material. The chain saw never contacts the ground during operation of the apparatus. One person can operate the apparatus safely with one hand on the chain saw throttle-grip and the other hand on the piece of material being sawed. The apparatus is portable and can be easily disassembled for storage.

The apparatus comprises a stand, a surface, and a swing-arm levering system. Material is placed on the surface of the stand and visually aligned to a scribed mark on the material or to an optional measuring guide that is set to a desirable length. The chain saw is carried by the swing-arm, by fixing the chain saw front handlebar to a brace and clamping assembly and by a positional brace and clamping assembly securely fastened to the chain saw guide-bar. A fulcrum is positioned to support the swing-arm and allows the swing-arm to pivot above the stand. The swing-arm and the stand accommodate a spring to counterbalance the chain saw. Tension on the spring can be adjusted to provide the proper balance for different types and sizes of chain saws. The balance keeps the chain saw over the material, and allows the operator to easily move the chain saw in a downward movement efficiently cross-cutting material. The stand can be easily assembled. In one embodiment supporting-legs insert into the bottom of the stand via a coupling connection and can be held in place with a combination of retaining devices.

The assembly herein is a chain saw stand comprising; a surface that supports a work piece, and a fulcrum to support a pivotal swing-arm at a pivot point, the pivot point dividing the swing-arm into portions, a first portion to attach a chain saw and a second portion to counterbalance the chain saw, levering the chain saw above the surface in a suspended state, wherein the chain saw together with the swing-arm may be moved downward by an operator to cut the work piece.

In one embodiment, the first portion of the swing-arm includes a bracing and clamping assembly to attach the chain saw.

In one embodiment, a power head of the chain saw protrudes from the first portion and the stand.

In one embodiment, the bracing and clamping assembly attach to a handlebar and to a guide-bar of the chain saw.

In one embodiment, a resilient member is fixed between the stand and the second portion to bias the first portion above the surface.

In one embodiment, the resilient member leverages the chain saw above the surface.

In one embodiment, the resilient member comprises; a coil-spring, an elastic band, a bungee-cord, a gas-filled strut, a torsion-bar, or a combination thereof.

In one embodiment, the resilient member counterbalances the chain saw by tension.

In one embodiment, the chain saw is suspended over a portion of the work piece placed in a cutting position on the surface.

In one embodiment, at least a portion of the work piece rests on the surface.

The assembly herein is a method of holding a chain saw comprising; bracing and clamping a chain saw to a pivoting swing-arm and resiliently leveraging the swing-arm at a pivot point on a fixed fulcrum, wherein the chain saw is suspending above a stand with a surface to place a work piece allowing an operator to move the chain saw downward to cut the work piece.

In one embodiment, a chain saw guide-bar is fixed to a positional brace that clamps to the swing-arm.

In one embodiment, the swing arm is fixed to a brace that clamps to a chain saw handlebar.

In one embodiment, resiliently leveraging the swing-arm comprises using a resilient member in tension selected from a coil-spring, an elastic band, a bungee-cord, a gas-filled strut, a torsion-bar, or a combination thereof to bias a first portion of the swing-arm above the surface.

In one embodiment, a portion of the work piece is placed on the surface.

### BRIEF DESCRIPTION OF THE DRAWINGS

For a better understanding of the invention, and to show more clearly how it may be carried in effect, embodiments will be described below, by way of example, with reference to the accompanying drawings, wherein;

FIG. 1 is a side view of the chain saw support apparatus, according to one embodiment shown with a wheelbarrow and with a chain saw attached.

FIG. 2 is a perspective view of the chain saw support apparatus of FIG. 1.

FIG. 3 is a partly sectional view of the swing-arm levering system of the embodiment of FIG. 1

FIG. 4 is a perspective view of the swing-arm and handlebar brace and clamping assembly of the embodiment in FIG. 1

FIG. 5 is a perspective view of the swing-arm positional brace and clamping assembly of the embodiment of FIG. 1.

FIG. 6 is a partially disassembled view of the stand, measuring-guide, supporting-legs and the T-shaped bracket of the embodiment of FIG. 1

### DETAILED DESCRIPTION OF THE PREFERRED EMBODIMENT

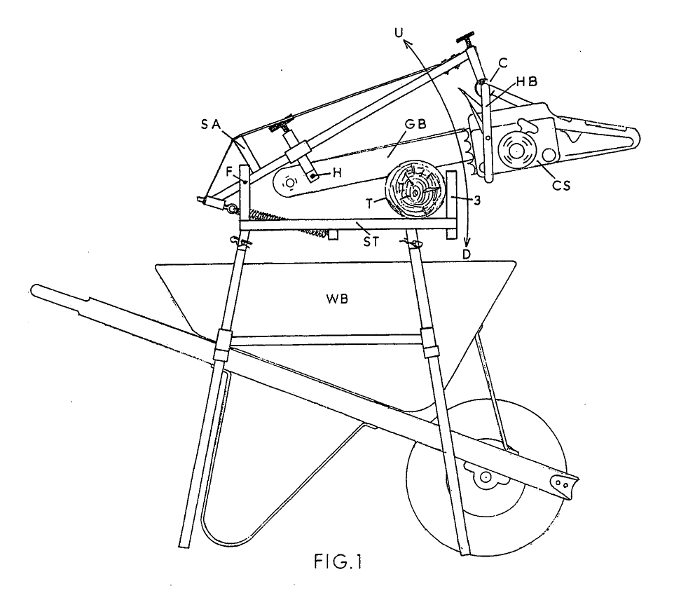

The support apparatus in FIG. 1 shown with a chain saw CS which is fastened to a swing-arm SA levering system placed above the apparatus stand ST with a fulcrum F to allow the chain saw to swing up and down U-D. This movement allows timber T to be easily cross-cut. The cut piece of material can then fall into a wheelbarrow WB as shown, or a trailer, a container, or a truck tail-gate, or on the ground.

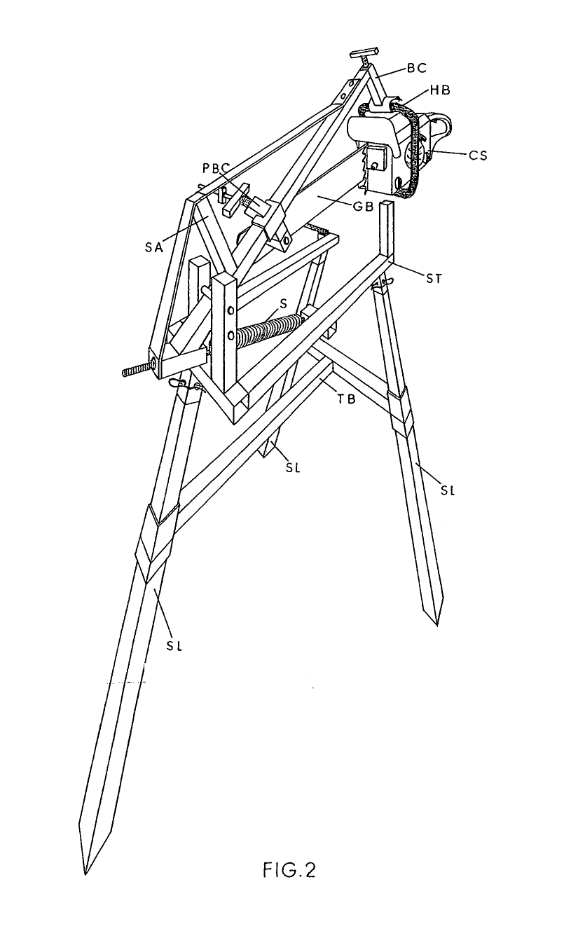

The swing arm SA in FIG. carries the chain saw CS by fixing a brace and clamping assembly B-C, to the chain saw front handlebar HB and by fixing a positional brace and clamping assembly PBC to the chain saw guide-bar GB. The swing-arm and the stand ST contain a spring S to counterbalance the chain saw. The stand ST has supporting-legs SL that splay outwards, or in one embodiment, one or more legs may be angled to fasten to a trailer, or a vehicle. The supporting-legs SL (shown in FIG. 2) is stabilized with a T-shaped bracket TB.

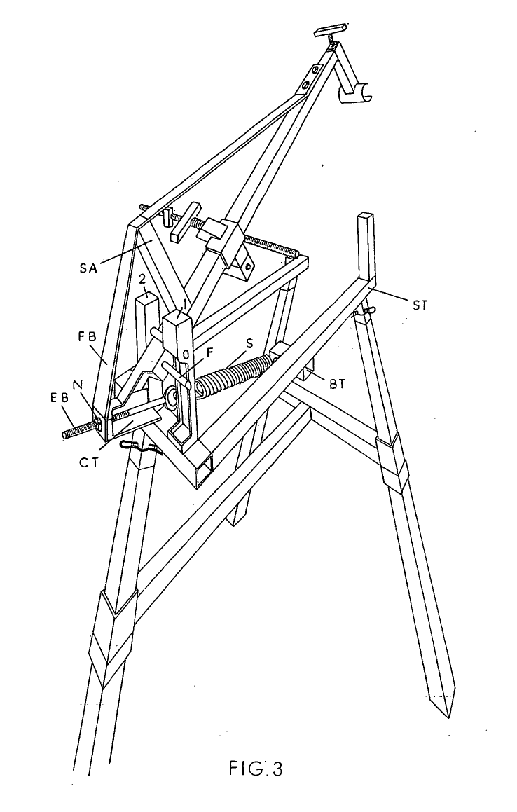

The swing-arm levering system shown in the embodiment of FIG. 3 includes a fulcrum F [pivot-point]on the swing-arm SA and on post members 1, 2 of the stand ST. Balancing the chain saw is conducted by a coil-spring S, or other means such as a elastic band, bungee-cord, gas-filled strut, torsion-bar or a combination of these. The spring S shown, connects to the bottom of the stand brace-tube BT. The spring S extends upwards between the post members 1, 2 and hooks into an eye-bolt EB. The eye-bolt passes through the swing-arm channel-tube CT and through a hole in the flat-bar FB. A nut N is used to secure the tension placed on the eye-bolt. The nut allows tension in the spring to be adjusted, there by balancing the chain saw. This allows the chain saw to be suspended above the work piece and also allows the chain saw to swing downward.

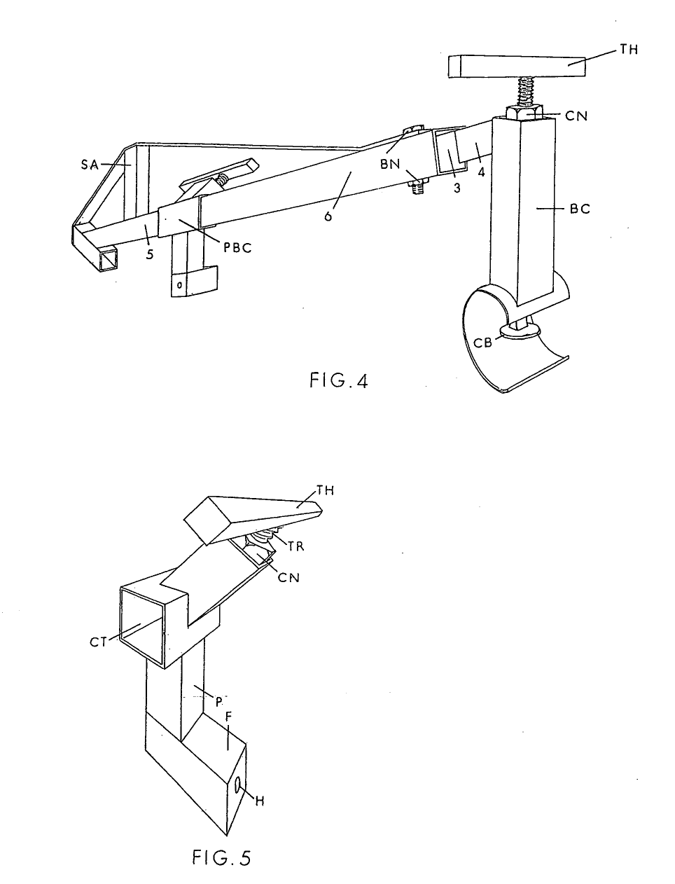

In the embodiment of the handlebar bracing and clamping assembly shown in FIG. 4 the brace BC includes a coupling-nut CN and a carriage-bolt CB arrangement. With the chain saw front handlebar HB placed in the channel C [shown in FIG. 1], the carriage-bolt CB is hand tighten to compress down on the handlebar, with the aid of a T-handle TH. The swing-arm SA accepts the brace BC via a coupling connection shown as 3 and 4, this connection is secured by a bolt-nut BN.

The swing-arm SA in the embodiment shown in FIG. 4 accepts the positional-bracing and clamping assembly PBC which moves and clamps securely along the swing-arm SA length shown between 5 and 6.

The positional bracing and clamping assembly embodiment shown in FIG. 5 comprises a channel-tube CT, a coupling-nut CN and a threaded-rod TR with a T-handle TH arrangement to provide a clamping force to lock the brace in position. The brace has lower members including a post P and a foot F. A bolt inserted through the hole H in the foot F and a hole H in the guide-bar GB [shown in FIG. 1] is fixed with a locking-nut.

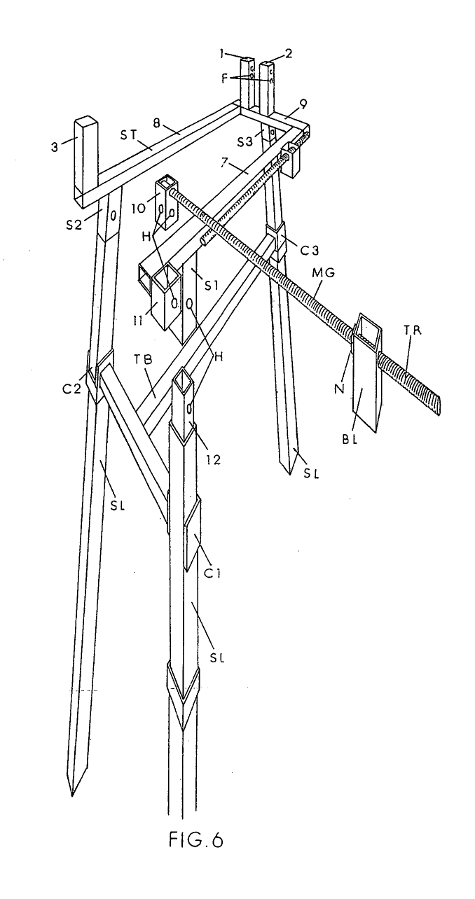

The partially disassembled view of the apparatus in FIG. 6 comprises the stand ST, including supporting-legs SL, T-shaped bracket TB, and an optional measuring-guide MG. The stand ST may include three portions 7, 8 and 9, with post members 1 and 2 placed on top of the stand to accept the fulcrum F and a third post 3 may be placed to stop the timber T from rolling off the stand as the timber is being sawed [shown in FIG. 1]. The stand may include sockets S1, S2 and S3 for removable attaching supporting legs SL. The sockets may be splayed outwards from the plane formed by portions 7, 8 and 9. The supporting-legs SL may include extensions [shown as 12] that engage the sockets S1, S2 , S3 and may be secured with a retaining device placed through the aligned holes H in the sockets S1, S2, S3 and in the extensions 12, such as bolt or a pin. The three supporting-legs SL are stabilized by a T-shaped bracket TB. The T-bracket has channeled ends that unite with the supporting-legs. In one embodiment two of the channeled ends shown as C1 and C2 are open on one side, the third channel C3 has four sides, and this is for easy assembly without the need for fasteners to secure the T-bracket TB. The optional measuring-guide MG may comprise a threaded-rod TR with a nut N attached to ballast BL for visually aligning the length of material being sawed, and a chamber 10 to couple with a side socket 11 on the stand ST. The measuring-guide may be secured with a spring-pin set diagonally through the united side-socket and chamber holes H, in a working or storage position.

While the invention has been described with respect to illustrative embodiments thereof, it will be understood that various changes may be made to the embodiments without departing from the scope of the invention. Accordingly, the described embodiments are to be considered merely exemplary and the invention is not to be limited thereby.

1. A chain saw stand, comprising;
a surface that supports a work piece; and a fulcrum to support a pivotal swing-arm at a pivot point, the pivot point dividing the swing-arm into portions, a first portion to attach a chain saw and a second portion to counterbalance the chain saw, levering the chain saw above the surface in a suspended state; wherein the chain saw together with the swing-arm may be moved downward by an operator to cut the work piece.

2. The chain saw stand of claim 1, wherein the first portion of the swing-arm includes a bracing and clamping assembly to attach the chain saw thereto.

3. The chain saw stand of claim 2, wherein a power head of the chain saw protrudes from the first portion and the stand.

4. The chain saw stand of claim 2, wherein the bracing and clamping assembly attach to a handlebar and to a guide-bar of the chain saw.

5. The chain saw stand of claim 1, wherein a resilient member is fixed between the stand and the second portion to bias the first portion above the surface.

6. The chain saw stand of claim 5, wherein the resilient member leverages the chain saw above the surface.

7. The chain saw stand of claim 6, wherein the resilient member comprises a coil-spring, a elastic band, a bungee-cord, a gas-filled strut, a torsion-bar, or a combination thereof.

8. The chain saw stand of claim 5, wherein the resilient member counterbalances the chain saw by extending tension or by compressed tension.

9. The chain saw stand of claim 1, wherein the chain saw is suspended over a portion of the work piece placed in a cutting position on the surface.

10. The chain saw stand of claim 9, wherein at least a portion of the work piece rests on the surface.

11. A method of holding a chain saw, comprising;
bracing and clamping a chain saw to a pivoting swing-arm and resiliently leveraging the swing-arm at a pivot point on a fixed fulcrum, wherein the chain saw is suspended above a stand with a surface to place a work piece allowing an operator to move the chain saw downward to cut the work piece.

12. The method of holding a chain saw of claim 11, wherein a chain saw guide-bar is fixed to a positional brace that clamps to the swing-arm.

13. The method of holding a chain saw of claim 11, wherein the swing-arm is fixed to a brace that clamps to a chain saw handle-bar.

14. The method of holding a chain saw of claim 11, wherein resiliently leveraging the swing-arm comprises using a resilient member selected from a coil spring, a elastic-band, a bungee-cord, a gas-filled strut, a torsion-bar, or a combination thereof, to bias a first portion of the swing-arm above the surface.

15. The method of holding a chain saw of claim 14, wherein the resilient member is in extending tension or compressed tension.

16. The method of holding a chain saw of claim 11, wherein a portion of the work piece is placed on the surface.
